(19) United States
(12) Patent Application Publication
(10) Pub. No.: US 2024/0039418 A1
(43) Pub. Date: Feb. 1, 2024

(54) DYNAMIC TRANSFORMER LOADING SYSTEMS, TRANSFORMER LOAD CONTROLLER AND METHODS OF STAGING A PLURALITY OF TRANSFORMERS IN ACCORDANCE WITH CURRENT LOAD REQUIREMENTS OF A CHANGING LOAD

(71) Applicant: ICKLER ELECTRIC CORPORATION, Poway, CA (US)

(72) Inventor: Randy Minnier, Poway, CA (US)

(21) Appl. No.: 18/226,391

(22) Filed: Jul. 26, 2023

Related U.S. Application Data
(60) Provisional application No. 63/394,032, filed on Aug. 1, 2022.

(51) Int. Cl. H02M 5/10

(52) U.S. Cl. CPC H02M 5/10

(57) ABSTRACT

Dynamic transformer loading systems for staging a plurality of transformers in accordance with current load requirements of a changing load. In one aspect, a dynamic transformer loading system is disclosed. The dynamic transformer loading system may include two or more transformers arranged in parallel; multiple current transducers, respective ones of the current transducers being in signal communication with respective ones of the transformers; multiple contactors, respective ones of the contactors enabling a given transformer or transformers to be operationally removed from the dynamic transformer loading system; and a transformer load controller which receives as input measurements from the current transducers, and in response outputs signals to the contactors. Methods of staging a plurality of transformers are also disclosed.

### PRIORITY

This application claims the benefit of priority to U.S. Provisional Patent Application Ser. No. 63/394,032 filed Aug. 1, 2022, entitled “Dynamic Transformer Loading Systems and Methods of Operation”, the contents of which being incorporated herein by reference in its entirety.

### COPYRIGHT

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever.

### BACKGROUND OF THE DISCLOSURE

### Field of the disclosure

The present disclosure relates generally to the field of energy conservation and in one exemplary aspect to dynamic transformer loading systems as well as methods of operating and using the same.

### Description of Related Art

The impacts of climate change have been increasingly understood to have broad and far-reaching environmental impacts that have affected our oceans, ice accumulation in the polar regions of our planet, as well as weather patterns around the globe. The main causes of climate change have been attributed to the emission of greenhouse gases, mainly carbon dioxide (CO₂) and methane. In response, the global community has implemented a wide swathe of government regulations with the intention of reducing fossil fuel consumption. In the state of California, Title 24 of the California Code of Regulations has implemented building code requirements that address, among other things, individual responsibility for businesses as well as individuals for the reduction of their respective carbon footprints. For example, Title 24 has implemented so-called demand response requirements which, in response to signals transmitted by utility companies, reduce the amount of energy consumed by heating, ventilation, and air conditioning (HVAC) systems; indoor lighting systems; as well as electronic message centers (also known as digital signage or digital billboards).

Despite the wide variety of energy conservation measures that have been implemented throughout the world, one overlooked item of wasted energy has been transformer inefficiencies that affect virtually every electric energy distribution system in the world. Historically, transformers are currently built as a single unit that is sized in accordance with the kilo volt-ampere (kVA) requirements for the network that the transformer is intended to service. However, most transformers are typically 15-60% loaded at any given time during their period of operation which results in sub-optimal operating efficiency for these transformers. Additionally, these transformer cores are often energized on a 24-hour per day/seven-day a week basis compounding the amount of wasted energy associated with their usage. Accordingly, there remains a salient need for systems and methodologies that address these inefficiencies present in current electrical distribution systems.

### SUMMARY

The present disclosure satisfies the foregoing needs by providing, inter alia, dynamic transformer loading systems as well as methods of their operation and use.

In one aspect, a dynamic transformer loading system is disclosed. In one embodiment, the dynamic transformer loading system includes a plurality of transformers arranged in parallel; a plurality of current transducers, respective ones of the plurality of current transducers being in electrical communication with respective ones of the plurality of transformers; a plurality of contactors, respective ones of the plurality of contactors enabling a given transformer or transformers of the plurality of transformers to be operationally removed or operationally enabled from the dynamic transformer loading system; and a transformer load controller which receives as input, measurements from the plurality of current transducers, and in response to the received measurements, output signals to one or more of the plurality of contactors.

In one variant, the measurements received by the transformer load controller enables the transformer load controller to stage each of the plurality of transformers.

In another variant, the measurements received by the transformer load controller includes information associated with a current load that the dynamic transformer loading system is servicing.

In yet another variant, the information associated with the current load enables the plurality of transformers arranged in parallel to be staged in accordance with load requirements of the current load that the dynamic transformer loading system is servicing.

In yet another variant, the information associated with the current load enables the transformer load controller to sequentially enable bringing an additional transformer of the plurality of transformers online once one or more currently active transformers exceed approximately 80% of the one or more currently active transformers load rating.

In yet another variant, the transformer load controller is further configured to receive signals transmitted by a utility, and in response, output signals to one or more of the plurality of contactors.

In yet another variant, the received signals transmitted by the utility comprise demand response and demand control signals in accordance with Title 24 Demand Response Requirements.

In another aspect, a transformer load controller is disclosed. In one embodiment, the transformer load controller includes a non-transitory computer readable medium, the non-transitory computer readable medium including a plurality of computer executable instructions, that when executed by a processor apparatus, enable the transformer load controller to: receive one or more signals from one or more of a plurality of current transducers, respective ones of the plurality of current transducers being indicative of current load requirements of a load that the transformer load controller is servicing; and in response to the received signals from the one or more of the plurality of current transducers, output one or more signals to one or more of a plurality of contactors, the one or more signals output to the one or more of the plurality of contactors enabling one or more of a plurality of transformers that are arranged in parallel to be either brought offline or brought online in order to service the load.

In one variant, the one or more signals received by the transformer load controller enables the transformer load controller to stage each of the plurality of transformers.

In another variant, the one or more signals received by the transformer load controller includes information associated with a current load that the plurality of transformers are servicing.

In yet another variant, the information associated with the current load enables the plurality of transformers arranged in parallel to be staged in accordance with current load requirements.

In yet another variant, the information associated with the current load enables the transformer load controller to sequentially enable bringing an additional transformer of the plurality of transformers online once one or more currently active transformers of the plurality of transformers exceed approximately 80% of the one or more currently active transformers load rating.

In yet another variant, the transformer load controller is further configured to receive signals transmitted by a utility, and in response, output signals to one or more of the plurality of contactors.

In yet another variant, the received signals transmitted by the utility comprise demand response and demand control signals in accordance with Title 24 Demand Response Requirements.

In yet another aspect, a method of staging a plurality of transformers that are arranged in parallel to support load requirements for a changing load are disclosed. In one embodiment, the method includes receiving one or more signals from one or more of a plurality of current transducers, the one or more signals received being indicative of current load requirements of the changing load; and in response to the receiving of the one or more signals from the one or more of the plurality of current transducers, outputting one or more signals to one or more of a plurality of contactors, the outputting of the one or more signals to the one or more of the plurality of contactors enabling one or more of the plurality of transformers that are arranged in parallel to be either brought offline or brought online in order to service the changing load.

In one variant, the receiving of the one or more signals from the one or more of the plurality of current transducers enables staging of the plurality of transformers to support the changing load.

In another variant, the staging of the plurality of transformers includes sequentially enabling an additional transformer of the plurality of transformers to be brought online once one or more currently active transformers of the plurality of transformers are exceeding approximately 80% of the one or more currently active transformers load rating.

In yet another variant, the method further includes receiving signals transmitted by a utility, and in response, outputting signals to one or more of the plurality of contactors.

In yet another variant, the receiving of the signals transmitted by the utility comprises receiving demand response and demand control signals in accordance with Title 24 Demand Response Requirements.

In yet another variant, in response to the receiving of the demand response and demand control signals in accordance with Title 24 Demand Response Requirements, transmitting one or more signals to the plurality of contactors in order to enable the one or more of the plurality of transformers that are arranged in parallel to be either brought offline or brought online in order to service the received demand response and demand control signals in accordance with Title 24 Demand Response Requirements.

In one embodiment, the dynamic transformer loading system includes two or more transformers arranged in parallel; multiple current transducers, respective ones of the current transducers being in signal communication with respective ones of the transformers; multiple contactors, respective ones of the contactors enabling a given transformer or transformers to be operationally removed from the dynamic transformer loading system; and a transformer load controller which receives as input measurements from the current transducers, and in response outputs signals to the contactors.

In another aspect, methods of operating or installing the aforementioned dynamic transformer loading system are disclosed. In one embodiment, the method includes receiving a signal at the dynamic transformer loading system from a utility, and in response, reducing or shutting off the load that the dynamic transformer loading system is servicing.

Other features and advantages of the present disclosure will immediately be recognized by persons of ordinary skill in the art with reference to the attached drawings and detailed description of exemplary implementations as given below.

### BRIEF DESCRIPTION OF THE DRAWINGS

FIG. 1A is a plot of transformer efficiency as a function of transformer loading, in accordance with the principles of the present disclosure.

FIG. 1B are plots of transformer efficiency as a function of load power factor, in accordance with the principles of the present disclosure.

FIG. 1C is a plot of transformer efficiency as a function of transformer loading for both a conventional transformer as well as an optimized amorphous transformer, in accordance with the principles of the present disclosure.

FIG. 2 is a system block diagram of an exemplary dynamic transformer loading system, in accordance with the principles of the present disclosure.

FIG. 3 is an electrical schematic of an exemplary dynamic transformer loading system, in accordance with the principles of the present disclosure.

All Figures disclosed herein are © Copyright 2022-2023
Ickler Electric Corporation
All rights reserved.

### DETAILED DESCRIPTION

Implementations of the present technology will now be described in detail with reference to the drawings, which are provided as illustrative examples to enable those skilled in the art to practice the technology. Notably, the figures and examples below are not meant to limit the scope of the present disclosure to any single implementation or implementations, but other implementations are possible by way of interchange of, substitution of, or combination with some or all of the described or illustrated elements. Wherever convenient, the same reference numbers will be used throughout the drawings to refer to same or like parts.

In some embodiments, numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the disclosure are approximations, the numerical values set forth in the specific examples are reported as precisely as practicable. The numerical values presented in some embodiments of the disclosure may contain certain errors necessarily resulting from the standard deviation found in their respective testing measurements.

Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the disclosure and does not pose a limitation on the scope of the disclosure otherwise claimed. No language in the specification should be construed as indicating any non-claimed element essential to the practice of the disclosure. Unless a contrary meaning is explicitly stated, all ranges are inclusive of their endpoints, and open-ended ranges are to be interpreted as bounded on the open end by commercially feasible embodiments.

### Background on Transformer Efficiencies

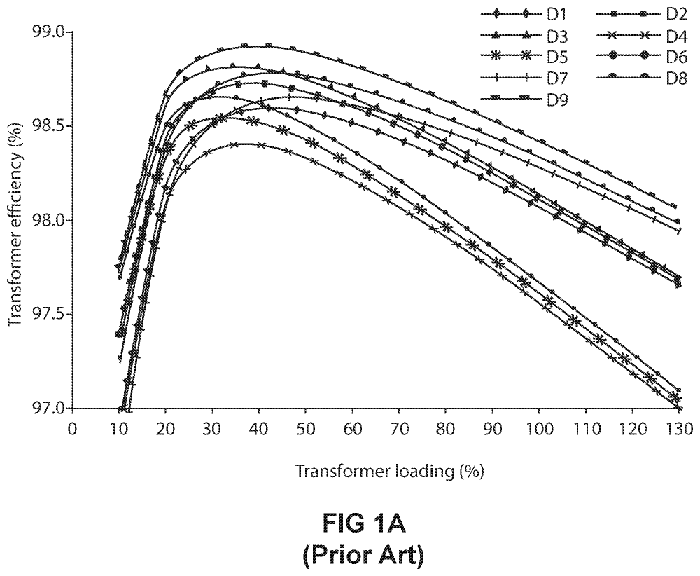

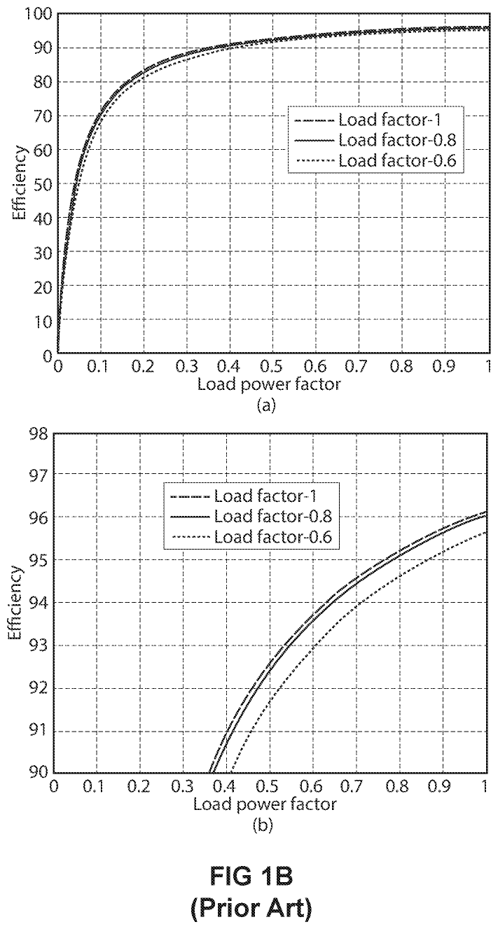

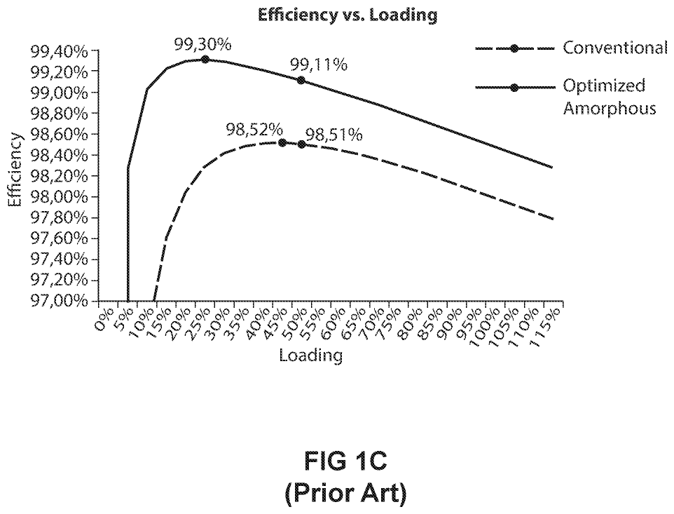

Referring now to FIG. 1A, a plot is illustrated which demonstrates transformer efficiency as a function of transformer loading for nine (9) distinct transformers. As a brief aside, the efficiency of a transformer is defined as the ratio of output power to input power for that transformer. Accordingly, the efficiency of an ideal transformer is 100% meaning that there are no losses associated with the transfer of power across that transformer. However, in real-life implementations transformers experience losses in the form of, inter alia: (1) winding losses; (2) eddy current losses; and (3) hysteresis losses. Winding losses are caused by the resistance of the underlying material from which the windings are manufactured (e.g., the primary and secondary windings), and these windings are typically manufactured from copper. As current flows through these windings, the resistance of these windings themselves results in the dissipation of energy in the form of heat. Winding losses are typically mitigated through the utilization of larger diameter conductors to reduce the resistance per unit length of the underlying material. Generally, winding losses are typically twice as much as the losses experienced by the core of the transformer itself. Eddy current losses are caused by the alternating magnetic fields induced in the core of the transformer resultant from the alternating current (AC) used in the windings of the transformer. Generally, eddy current losses increase as a function of frequency and are directly proportional to the square of the AC frequency. Hysteresis losses result from the tendency of the core material to lag in its acceptance of a fluctuating magnetic field.

Referring again to FIG. 1A, and looking at transformer D4 as an example, the transformer D4 maintains an efficiency greater than 98% when the transformer is loaded between about 20% and 75% of its operational loading capacity. However, when operating below a 20% operational loading capacity, the efficiency of the transformer markedly decreases. For example, when transformer D4 is operated at a loading percentage of 10%, the efficiency of transformer D4 is less than about 97% efficient. Operating at a higher transformer loading percentage also results in reduced transformer efficiency, albeit typically not as inefficient as when the transformer is operating at lower loading percentages. For example, with transformer D4, the transformer efficiency is just above 97.5% at 100% loading.

Referring now to FIG. 1B, two plots of transformer efficiency as a function of load power factor are illustrated. One plot illustrates transformer efficiency as a function of load power factor across the entire range of efficiency and load power factor, while the other plot illustrates transformer efficiencies between 90% and 98% as a function of load power factor. The load power factor is defined as the ratio of the real power absorbed by the load to the apparent power flowing in the circuit. The apparent power may be larger than the real power due to, for example, energy stored in the load returning to the source and/or due to a non-linear load that distorts the wave shape of the current drawn from the source. As can be seen in the plots illustrated in FIG. 1B, as the load power factor drops below approximately 0.4, the transformer efficiency drops off precipitously.

Referring now to FIG. 1C, a plot of transformer efficiency as a function of transformer loading for both a conventional transformer as well as an optimized amorphous transformer is shown. An amorphous metal transformer (AMT) is a type of energy efficient transformer that has been widely adopted in some large developing countries such as China and India. The magnetic core of these AMTs is made from a ferromagnetic amorphous metal, typically an alloy consisting of iron, boron, silicon and phosphorous manufactured in the form of relatively thin foils that are rapidly cooled during manufacture. AMTs are typically more efficient than their counterpart conventional transformers manufactured from crystalline iron-silicone steel. However, AMTs are more labor-intensive in their manufacture making them less widely adopted in markets in which labor costs are relatively high. Regardless, despite the advantages in efficiencies seen with AMTs as compared with their conventional transformer counterparts, overall inefficiencies remain outside of optimum loading conditions.

### Exemplary Dynamic Transformer Loading Systems

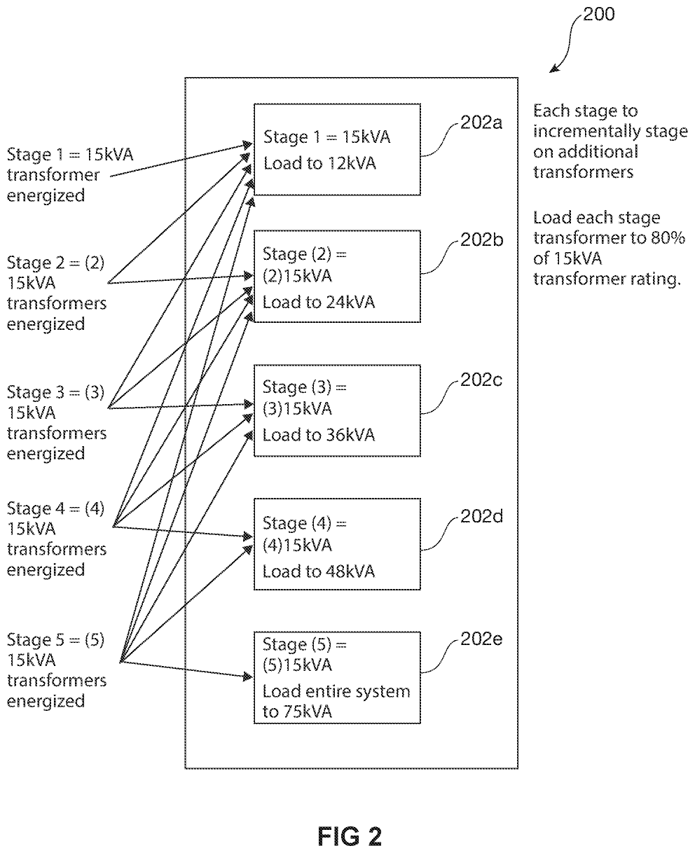

Referring now to FIG. 2, a system block diagram of an exemplary dynamic transformer loading system 200, in accordance with the principles of the present disclosure is shown and described in detail. The exemplary dynamic transformer loading system 200 overcomes the deficiencies of the single transformer paradigm that has been ubiquitously adopted throughout the wide variety of electrical utilities utilized throughout the world. The underlying principle behind the dynamic transformer loading system 200 is to stage multiple transformers 202 in parallel and increment their usage as the load coupled to the dynamic transformer loading system 200 changes. In addition, a dynamic transformer loading system 200 enables an entire transformer 202 (or two or more transformers) to go into a “sleep mode” when not needed. In other words, these sleep mode transformers may be removed from the power transfer circuitry altogether. Accordingly, by staging transformers 202 in smaller increments for the total rated capacity of the circuit to which the transformers are supplying energy, the dynamic transformer loading system 200 reduces winding and core losses, thereby increasing the efficiency of the overall power transfer system.

In the example illustrated in FIG. 2, a dynamic transformer loading system 200 is rated to load the entire system up to a total of 75 kVA. The dynamic transformer loading system consists of five (5) independent transformers 202 that function in parallel with one another, with each transformer of the dynamic transformer loading system handling a load of up to 15 kVA. While the present example, contemplates an entire system load of 75 kVA, it would be readily appreciated that the principles of the present disclosure may be readily applied to systems having a capacity of fewer than 75 kVA or a system having more capacity than 75 kVA, the 75 kVA example is merely being introduced as exemplary. In addition, while the example shown in FIG. 2 illustrates five (5) independent transformers 202, it would be readily appreciated that fewer than five (5) transformers 202 may be utilized in some implementations, or more than five (5) transformers 202 may be utilized in other implementations.

In the example illustrated in FIG. 2, the stage 1 transformer 202a of the dynamic transformer loading system 200 is intended to operate with loads up to 12 kVA, while the stage 2 through 5 transformers 202b-202e remain in sleep mode (i.e., disconnected from the load). At loads greater than 12 kVA, but less than 24 kVA, the stage 2 transformer 202b is energized, and the load is supplied from the stage 1 and stage 2 transformers 202a/202b, while the stage 3 through 5 transformers 202c-202e remain in sleep mode. At loads greater than 24 kVA, but less than 36 kVA, the stage 3 transformer 202c is energized, and the load is supplied from the stage 1-stage 3 transformers 202a-202c, while the stage 4 and 5 transformers 202d/202e remain in sleep mode. At loads greater than 36 kVA, but less than 48 kVA, the stage 4 transformer 202d is energized, and the load is supplied from the stage 1 through stage 4 transformers 202a-202d, while the stage 5 transformer 202e remains in sleep mode. At loads greater than 48 kVA, the stage 5 transformer 202e is energized, and all five stages of transformers 202 are utilized to provide power to the load. In other words, and in this example, the dynamic transformer loading system 200 loads each stage transformer to approximately 80% (e.g., between 75% and 85%, or between 70% and 90%, etc., dependent upon, for example, the operational characteristics of the transformer being utilized) of its transformer rating before incrementing an additional transformer within the operation of the dynamic transformer loading system 200. While specific loading requirements have been illustrated in the embodiment illustrated in FIG. 2, it would be readily apparent to one of ordinary skill given the contents of the present disclosure that the specific numerical values given may be dependent upon, for example, the specific transformer operating parameters chosen for a given dynamic transformer loading system 200. For example, these staging values may differ dependent upon whether an AMT has been chosen versus a conventional transformer. These staging values may also differ dependent upon the differing performance parameters associated with a given transformer, with the example illustrated in FIG. 2 merely being exemplary.

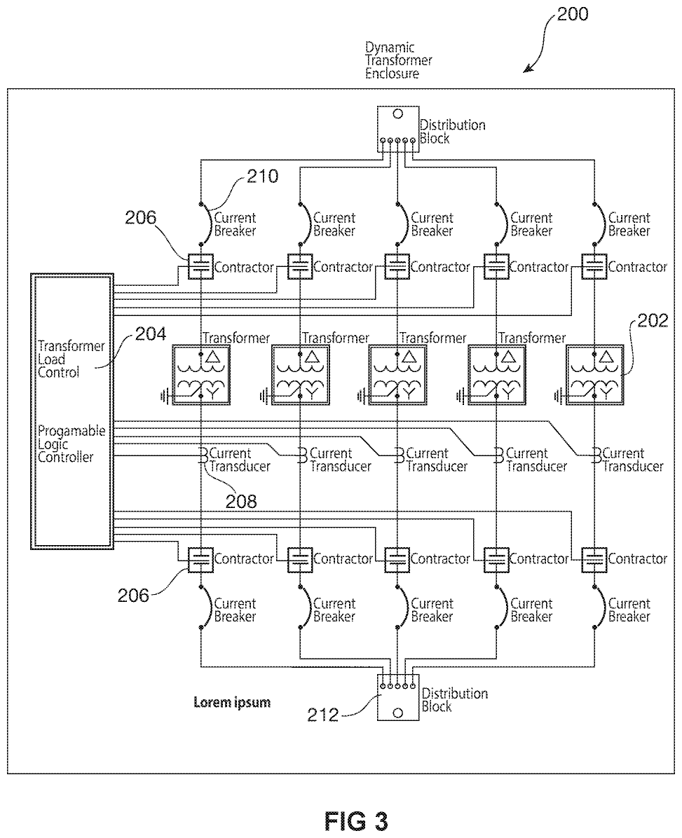

Referring now to FIG. 3, an electrical schematic for an exemplary dynamic transformer loading system 200 in accordance with the principles of the present disclosure is shown and described in detail. The dynamic transformer loading system 200 may include one or more controllers 204 (e.g., a programmable logic controller) that controls when to engage or disengage various ones of the contactors 206 that enables a given transformer 202 to form (or not form) part of the dynamic transformer loading system 200. For example, a signal sent from the controller(s) 204 may cause the contactor 206 to add a given transformer 202 to the system 200 or may cause the contactor 206 to remove a given transformer 202 from the system 200. In some implementations, the controller(s) 204 may read a current value from the current transducer 208. Once this current value is read, the controller(s) may determine whether the system 200 may operate more efficiently with the addition of one or more additional transformers 202. If it is determined that the system 200 would operate more efficiently with the addition of one or more additional transformers 202, the controller(s) 204 may output a signal to other ones of the contactor(s) 206, thereby bringing these one or more additional transformers 202 online.

The functionality of the controller(s) 204 described herein may be implemented through use of software and/or firmware executed by the one or more controllers (or processors) and/or may be executed via the use of one or more dedicated hardware modules. The computer code may consist of computer-readable instructions stored in a non-transitory computer-readable medium that may be executed by one or more controllers (or processors), whether off-the-shelf or custom manufactured. The controller(s) may be used to execute instructions (e.g., program code or software) for causing the controller(s) to execute the computer code for implementing the functionality described herein.

An exemplary controller 204 may include one or more processing units (generally processor apparatus). The processor apparatus may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of the foregoing. The controller(s) may also include a main memory. The controller(s) 204 may also include a storage unit. The controller(s), memory and the storage unit may communicate via a bus.

The storage unit includes a non-transitory computer-readable medium on which is stored instructions (e.g., software) embodying any one or more of the methodologies or functions described herein. The instructions may also reside, completely or at least partially, within the main memory or within the controller(s) (e.g., within a processor's cache memory) during execution thereof by the computing system, the main memory and the processor also constituting non-transitory computer-readable media. The instructions may be transmitted or received over a network via a communication interface.

While non-transitory computer-readable medium is shown in an example embodiment to be a single medium, the term “non-transitory computer-readable medium” should be taken to include a single medium or multiple media (e.g., a centralized or distributed database, or associated caches and servers) able to store the instructions. The term “non-transitory computer-readable medium” shall also be taken to include any medium that is capable of storing instructions for execution by the computing system and that cause the computing system to perform, for example, one or more of the methodologies disclosed herein.

The controller(s) 204 may receive as input, measurements received from respective current transducers 208. These current transducers 208 may provide the controller(s) 204 with information pertaining to the amount of load being drawn from the dynamic transformer loading system 200 via, for example, the distribution block 212. These current transducers 208 may convert one form of energy into another (e.g., the current measured in amperes may be converted into a representative standard analog (or digital) signal which is indicative of, for example, the amount of current being drawn by the load). In some implementations, these current transducers 208 may transmit their representative standard signals to a processor, and/or a processor may read these representative standard signals from the current transducers 208, and the processor may then convert these representative standard signals to another format and then transmit these formatted signals to the controller 204.

The dynamic transformer loading system 200 may also include circuit breakers 210 positioned on one or both sides of the transformers 202 to enable a given transformer 202 to be taken offline (or be placed online) should it be deemed necessary. The dynamic transformer loading system 200 may not only react to fluctuations within the load of the system that the dynamic transformer loading system 200 is intended to service but may also provide demand response and demand control in accordance with, for example, Title 24 Demand Response Requirements. In other words, in response to a signal provided by, for example, a utility, the dynamic transformer loading system 200 may shut down the load provided by the system 200 (or may shut down a subset of transformers 202 for the system 200). For example, in response to signals received from a utility, the system 200 may provide a signal to the contactors 206, thereby shutting off the power provided to the load.

### Exemplary Operating Scenario

Table 1 reproduced below illustrates one exemplary daily operating scenario for a dynamic transformer loading (“DTL”) system 200 as compared with a conventional 75 kVA transformer system.

TABLE 1

| Load | Hours | 75 kVA | DTL | 75 kVA | DTL |
|---|---|---|---|---|---|
| 20% | 4 | 3.60 | 2.40 | $0.90 | $0.60 |
| 25% | 2 | 1.99 | 1.47 | $0.50 | $0.37 |
| 30% | 2 | 2.07 | 1.87 | $0.52 | $0.47 |
| 35% | 2.5 | 2.92 | 2.56 | $0.73 | $0.64 |
| 40% | 3 | 3.87 | 3.65 | $0.97 | $0.91 |
| 45% | 3 | 4.20 | 4.20 | $1.05 | $1.05 |
| 50% | 1 | 1.50 | 1.47 | $0.38 | $0.37 |
| 55% | 1.25 | 2.04 | 2.11 | $0.51 | $0.53 |
| 60% | 2 | 3.51 | 3.74 | $0.88 | $0.93 |
| 65% | 1 | 1.95 | 1.95 | $0.49 | $0.49 |
| 70% | 1.25 | 2.69 | 2.69 | $0.67 | $0.67 |
| 75% | 1 | 2.33 | 2.33 | $0.58 | $0.58 |
| 80% | 0 | 0.00 | 0.00 | $0.00 | $0.00 |
| 85% | 0 | 0.00 | 0.00 | $0.00 | $0.00 |
| 90% | 0 | 0.00 | 0.00 | $0.00 | $0.00 |
| 95% | 0 | 0.00 | 0.00 | $0.00 | $0.00 |
| 100% | 0 | 0.00 | 0.00 | $0.00 | $0.00 |
| | 24 | 32.67 | 30.43 | $8.17 | $7.61 |

Table 1 illustrates the operational load over a typical 24-hour period of time for both a conventional 75kVA system as well as a dynamic transformer loading system 200 in accordance with the principles of the present disclosure. In the example illustrated above, the operational load is at 20% capacity for four (4) hours of the day; at 25% capacity for two (2) hours of the day; at 30% capacity for two (2) hours of the day; at 35% capacity for two and a half (2.5) hours of the day; at 40% capacity for three (3) hours of the day; at 45% capacity for three (3) hours of the day; at 50% capacity for one (1) hour of the day; at 55% capacity for one and a quarter (1.25) hours of the day; at 60% capacity for two (2) hours of the day; at 65% capacity for one (1) hour of the day; at 70% capacity for one and a quarter (1.25) hours of the day; and at 75% capacity for one (1) hour of the day.

Under this operating scenario, a conventional 75 kVA system might consume 32.67 kWh of energy from a utility in an exemplary day, while an exemplary dynamic transformer loading system 200 might consume 30.43 kWh of energy from the same utility, under the same loading conditions, in a given day. Accordingly, the energy savings over a period of one year will save on the order of roughly 816 kWh per year in this example. Additionally, and assuming a cost of $0.25 per kWh, a consumer would expect to save roughly $200 per year operating under a dynamic transformer loading system 200 as compared with a conventional 75 kVA system.

Where certain elements of these implementations can be partially or fully implemented using known components, only those portions of such known components that are necessary for an understanding of the present disclosure are described, and detailed descriptions of other portions of such known components are omitted so as not to obscure the disclosure.

In the present specification, an implementation showing a singular component should not be considered limiting; rather, the disclosure is intended to encompass other implementations including a plurality of the same component, and vice versa, unless explicitly stated otherwise herein.

Further, the present disclosure encompasses present and future known equivalents to the components referred to herein by way of illustration.

It will be recognized that while certain aspects of the technology are described in terms of a specific sequence of steps of a method, these descriptions are only illustrative of the broader methods of the disclosure and may be modified as required by the particular application. Certain steps may be rendered unnecessary or optional under certain circumstances. Additionally, certain steps or functionality may be added to the disclosed implementations, or the order of performance of two or more steps permuted. All such variations are considered to be encompassed within the disclosure disclosed and claimed herein.

While the above detailed description has shown, described, and pointed out novel features of the disclosure as applied to various implementations, it will be understood that various omissions, substitutions, and changes in the form and details of the device or process illustrated may be made by those skilled in the art without departing from the disclosure. The foregoing description is of the best mode presently contemplated of carrying out the principles of the disclosure. This description is in no way meant to be limiting, but rather should be taken as illustrative of the general principles of the technology. The scope of the disclosure should be determined with reference to the claims.

What is claimed:

1. A dynamic transformer loading system comprising:
a plurality of transformers arranged in parallel;
a plurality of current transducers, respective ones of the plurality of current transducers being in electrical communication with respective ones of the plurality of transformers;
a plurality of contactors, respective ones of the plurality of contactors enabling a given transformer or transformers of the plurality of transformers to be operationally removed or operationally enabled from the dynamic transformer loading system; and
a transformer load controller which receives as input, measurements from the plurality of current transducers, and in response to the received measurements, output signals to one or more of the plurality of contactors.

2. The dynamic transformer loading system of claim 1, wherein the measurements received by the transformer load controller enables the transformer load controller to stage each of the plurality of transformers arranged in parallel.

3. The dynamic transformer loading system of claim 2, wherein the measurements received by the transformer load controller comprises information associated with a current load that the dynamic transformer loading system is servicing.

4. The dynamic transformer loading system of claim 3, wherein the information associated with the current load enables the plurality of transformers arranged in parallel to be staged in accordance with load requirements of the current load that the dynamic transformer loading system is servicing.

5. The dynamic transformer loading system of claim 3, wherein the information associated with the current load enables the transformer load controller to sequentially enable bringing an additional transformer of the plurality of transformers online once one or more currently active transformers exceed approximately 80% of the one or more currently active transformers load rating.

6. The dynamic transformer loading system of claim 1, wherein the transformer load controller is further configured to receive signals transmitted by a utility, and in response, output signals to one or more of the plurality of contactors.

7. The dynamic transformer loading system of claim 6, wherein the received signals transmitted by the utility comprise demand response and demand control signals in accordance with Title 24 Demand Response Requirements.

8. A transformer load controller comprising a non-transitory computer readable medium, the non-transitory computer readable medium comprising a plurality of computer executable instructions, that when executed by a processor apparatus, enable the transformer load controller to:
receive one or more signals from one or more of a plurality of current transducers, respective ones of the plurality of current transducers being indicative of current load requirements of a load that the transformer load controller is servicing; and
in response to the received signals from the one or more of the plurality of current transducers, output one or more signals to one or more of a plurality of contactors, the one or more signals output to the one or more of the plurality of contactors enabling one or more of a plurality of transformers that are arranged in parallel to be either brought offline or brought online in order to service the load.

9. The transformer load controller of claim 8, wherein the one or more signals received by the transformer load controller enables the transformer load controller to stage each of the plurality of transformers.

10. The transformer load controller of claim 9, wherein the one or more signals received by the transformer load controller comprises information associated with a current load that the plurality of transformers are servicing.

11. The transformer load controller of claim 10, wherein the information associated with the current load enables the plurality of transformers arranged in parallel to be staged in accordance with current load requirements.

12. The transformer load controller of claim 10, wherein the information associated with the current load enables the transformer load controller to sequentially enable bringing an additional transformer of the plurality of transformers online once one or more currently active transformers of the plurality of transformers exceed approximately 80% of the one or more currently active transformers load rating.

13. The transformer load controller of claim 8, wherein the transformer load controller is further configured to receive signals transmitted by a utility, and in response, output signals to one or more of the plurality of contactors.

14. The transformer load controller of claim 13, wherein the received signals transmitted by the utility comprise demand response and demand control signals in accordance with Title 24 Demand Response Requirements.

15. A method of staging a plurality of transformers that are arranged in parallel to support load requirements for a changing load, the method comprising:
receiving one or more signals from one or more of a plurality of current transducers, the one or more signals received being indicative of current load requirements of the changing load; and
in response to the receiving of the one or more signals from the one or more of the plurality of current transducers, outputting one or more signals to one or more of a plurality of contactors, the outputting of the one or more signals to the one or more of the plurality of contactors enabling one or more of the plurality of transformers that are arranged in parallel to be either brought offline or brought online in order to service the changing load.

16. The method of claim 15, wherein the receiving of the one or more signals from the one or more of the plurality of current transducers enables staging of the plurality of transformers to support the changing load.

17. The method of claim 16, wherein the staging of the plurality of transformers comprises sequentially enabling an additional transformer of the plurality of transformers to be brought online once one or more currently active transformers of the plurality of transformers exceeding approximately 80% of the one or more currently active transformers load rating.

18. The method of claim 15, further comprising receiving signals transmitted by a utility, and in response, outputting signals to one or more of the plurality of contactors.

19. The method of claim 18, wherein the receiving of the signals transmitted by the utility comprises receiving demand response and demand control signals in accordance with Title 24 Demand Response Requirements.

20. The method of claim 19, wherein in response to the receiving of the demand response and demand control signals in accordance with Title 24 Demand Response Requirements, transmitting one or more signals to the plurality of contactors in order to enable the one or more of the plurality of transformers that are arranged in parallel to be either brought offline or brought online in order to service the received demand response and demand control signals in accordance with Title 24 Demand Response Requirements.
